(19) United States
(12) Patent Application Publication
(10) Pub. No.: US 2026/0119632 A1
(43) Pub. Date: Apr. 30, 2026

(54) Methods Circuits Devices Systems and Functionally Associated Machine Executable Code for Digital Device Display Viewing-Characteristics Based Authentication

(71) Applicant: Gabriel Ovadia, Hagor (IL)

(72) Inventor: Gabriel Ovadia, Hagor (IL)

(21) Appl. No.: 19/369,241

(22) Filed: Oct. 26, 2025

Related U.S. Application Data
(60) Provisional application No. 63/713,083, filed on Oct. 29, 2024.
(60) Provisional application No. 63/713,085, filed on Oct. 29, 2024.

(51) Int. Cl. G06F 21/32; G06V 40/18

(52) U.S. Cl. CPC G06F 21/32; G06V 40/197

(57) ABSTRACT

Disclosed is a system for digital device display viewing-characteristics based authentication. On more user-specific digital device display viewing-characteristics are monitored for, detected and stored. Newly obtained viewing-characteristics of a user attempting to access a digital data resource or network are compared to stored user-specific viewing-characteristics, wherein a match between the newly obtained viewing-characteristics and stored viewing-characteristics of a specific-user grants one or more access credentials associated with the matched—stored viewing-characteristics—user to the access attempting user.

### RELATED APPLICATIONS SECTION

The present application claims priority from U.S. Provisional Patent Application Nos. 63/713,083, filed Oct. 29, 2024, and 63/713,085, filed Oct. 29, 2024. All listed related applications are hereby incorporated by reference in their entirety.

### FIELD OF THE INVENTION

The present invention generally relates to the fields of user authentication, access control and cybersecurity. More specifically, the present invention relates to methods circuits devices systems and functionally associated machine executable code for digital device display viewing-characteristics based authentication.

### BACKGROUND

User authentication verifies the identity of a user attempting to gain access to a network or computing resource, by authorizing a human-to-machine transfer of credentials during interactions on a network or a device, to confirm a user's authenticity.

There remains a need, in the fields of user authentication, biometrics, access control and cybersecurity, for solutions facilitating user authentication based on user-specific characteristics of interfacing and engaging with a digital display of a computerized device.

### SUMMARY OF THE INVENTION

Embodiments of the present invention include methods circuits devices systems and functionally associated machine executable code for digital device display viewing-characteristics based authentication.

A system for digital device display viewing-characteristics based authentication, in accordance with embodiments, may facilitate the authentication of a digital device user based on one or more display viewing-characteristics of that user.

Biometric authentication may be executed using eye movement characteristics of users. Eye tracking data, such as pupil/eye size, pupil/eye movement direction, eye/pupil/iris deformation and flexion and/or microsaccades features-optionally in combination with environmental factors—may be monitored and user viewing-characteristics profiles generated based thereof.

A digital device utilized for viewing-characteristics based biometric authentication, in accordance with embodiments, may include any type of digital device, component, apparatus, or system that comprises eye tracking capabilities, such as, but not limited to: a mobile communication device, a personal computer, a wearable digital device such as smart glasses, security or surveillance cameras, an eye reader or scanner, and/or other.

A system for digital device display viewing-characteristics based authentication, may authenticate a digital device user, based on an outcome of a comparison between (1) a profile factoring one or more display viewing-characteristics of that user; and (2) stored/pre-generated viewing-characteristics profiles of other users and/or entities.

According to some embodiments, a system for digital device display viewing-characteristics based authentication may: (1) Monitor multiple users' digital display viewing-characteristics; (2) Generate and store viewing-characteristics values, signatures, behaviors, profiles and/or trends, along time, for multiple users; (3) Compare a new set of monitored viewing-characteristics data, of a specific user, to stored records of users' viewing-characteristics data; and/or (4) If the new set of monitored viewing-characteristics data is successfully matched to a stored record of a user's viewing-characteristics data-authenticate the specific user and/or grant the specific user with one or more access permissions/credentials associated with the matched user's permissions/credentials.

Viewing-characteristics, in accordance with embodiments, may include any type of eye or pupil positioning, rotational positioning and/or movement, such as one or more pupil positions/rotational-positions, and/or pupil micro-movements along a period of time. Multiple pupil positions along a period of time may be analyzed/processed to generate pupil trajectories typical to specific user(s).

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings:

FIG. 1 is a block diagram of an exemplary system for digital device display viewing-characteristics based authentication, in accordance with some embodiments;

FIG. 2 is a flowchart of an exemplary method for digital device display viewing-characteristics based authentication, in accordance with some embodiments:

FIG. 3 is a flowchart of an exemplary method for digital device display viewing-characteristics based authentication, wherein a new set of monitored viewing-characteristics, and a stored record viewing-characteristics, are both obtained-during/associated-with a similar scenario, in accordance with some embodiments:

FIG. 4A is a flowchart of an exemplary, Static Fixation Signature Analysis based method for digital device display viewing-characteristics based authentication, wherein users are authenticated based on involuntary, fine-motor movements of their eyes when they are fixating on a specific point, in accordance with some embodiments:

FIG. 4B is a flowchart of an exemplary, Dynamic Gaze Trajectory Analysis based method for digital device display viewing-characteristics based authentication, wherein users are authenticated by analyzing the unique way their eyes move while performing a guided task on a screen, in accordance with some embodiments:

FIG. 5A is an illustration of a simplified version of an exemplary ‘eye/pupil tracking over time’ based user profile/signature, of a system for digital device display viewing-characteristics based authentication, in accordance with some embodiments:

FIG. 5B an illustration of a simplified exemplification of a successful, ‘eye/pupil tracking over time’ user profile/signature based, authentication, of a system for digital device display viewing-characteristics based authentication, in accordance with some embodiments:

FIG. 5C is an illustration of a simplified exemplification of an unsuccessful, ‘eye/pupil tracking over time’ user profile/signature based, authentication, of a system for digital device display viewing-characteristics based authentication, in accordance with some embodiments;

FIG. 6 is a block diagram of an exemplary system for digital device display viewing-characteristics based visual impairment detection, diagnosis and trend analysis, in accordance with some embodiments;

FIG. 7 is a flowchart of an exemplary method for digital device display viewing-characteristics based visual impairment detection, diagnosis and trend analysis, in accordance with some embodiments; and

FIG. 8 is a flowchart of an exemplary method for digital device display viewing-characteristics based visual impairment detection, diagnosis and trend analysis, wherein a new set of monitored viewing-characteristics, and a stored record viewing-characteristics, are both obtained-during/associated-with a similar scenario, in accordance with some embodiments.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals or element labeling may be repeated among the figures to indicate corresponding or analogous elements.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Unless specifically stated otherwise, as apparent from the following discussions, it is appreciated that throughout the specification discussions utilizing terms such as “processing”, “computing”, “calculating”, “determining”, or the like, may refer to the action and/or processes of a computer, computing system, computerized mobile device, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In addition, throughout the specification discussions utilizing terms such as “storing”, “hosting”, “caching”, “saving”, or the like, may refer to the action and/or processes of ‘writing’ and ‘keeping’ digital information on a computer or computing system, or similar electronic computing device, and may be interchangeably used. The term “plurality” may be used throughout the specification to describe two or more components, devices, elements, parameters and the like.

Some embodiments of the invention, for example, may take the form of an entirely hardware embodiment, an entirely software embodiment, or an embodiment including both hardware and software elements. Some embodiments may be implemented in software, which includes but is not limited to firmware, microcode, or the like.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device, for example a computerized device running a web-browser.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and an optical disk. Some demonstrative examples of optical disks include compact disk-read only memory (CD-ROM), compact disk-read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution. The memory elements may, for example, at least partially include memory/registration elements on the user device itself.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “includes”, “including”, “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

The present disclosure is to be considered as an exemplification of the invention and is not intended to limit the invention to the specific embodiments illustrated by the figures or description below.

Embodiments of the present invention include methods circuits devices systems and functionally associated machine executable code for digital device display viewing-characteristics based authentication. Biometric authentication may be executed using eye movement characteristics of users. Eye tracking data, such as pupil/eye size, pupil/eye movement direction, eye/pupil/iris deformation and flexion and/or microsaccades features—optionally in combination with environmental factors—may be monitored and user viewing-characteristics profiles generated based thereof.

A digital device utilized for viewing-characteristics based biometric authentication, in accordance with embodiments, may include any type of digital device, component, apparatus, or system that comprises eye tracking capabilities, such as, but not limited to: a mobile communication device, a personal computer, a wearable digital device such as smart glasses, security or surveillance cameras, an eye reader or scanner, and/or other.

A system for digital device display viewing-characteristics based authentication, may authenticate a digital device user, based on an outcome of a comparison between (1) a profile factoring one or more display viewing-characteristics of that user; and (2) stored/pre-generated viewing-characteristics profiles of other users and/or entities.

According to some embodiments, a system for digital device display viewing-characteristics based authentication may: (1) Monitor multiple users' digital display viewing-characteristics; (2) Generate and store viewing-characteristics values, signatures, behaviors, profiles and/or trends, along time, for multiple users; (3) Compare a new set of monitored viewing-characteristics data, of a specific user, to stored records of users' viewing-characteristics data; and/or (4) If the new set of monitored viewing-characteristics data is successfully matched to a stored record of a user's viewing-characteristics data-authenticate the specific user and/or grant the specific user with one or more access permissions/credentials associated with the matched user's permissions/credentials.

Viewing-characteristics, in accordance with embodiments, may include any type of eye or pupil positioning, rotational positioning and/or movement, such as one or more pupil positions/rotational-positions, and/or pupil micro-movements along a period of time. Multiple pupil positions along a period of time may be analyzed/processed to generate pupil trajectories typical to specific user(s).

A dataset of a user's unique viewing-characteristics, in accordance with embodiments, may for example include a combination of acquired/captured/extracted data points, such as: (1) Eye and Pupil Features: Pupil rolling, focus, size, and/or direction; (2) Involuntary Movements: positions, rotational positions, fixational ocular motoric activity, size, and/or direction of Microsaccades-unique subconscious eye movements, which typically occur during visual fixation; and/or (3) Environment Context: Data such as temperature, precipitation, location, whether the user is viewing content on the device or in their surroundings.

Microsaccades parameterization, in accordance with embodiments, may include one or more Microsaccade features defined on a set of points/values describing the trajectory of the gaze of the user along a time segment of a detected visual fixation. Defined Microsaccade features may for example include: Microsaccade duration, height, area, sharpness, base length, double-Microsaccade features, average speed, maximal speed (optionally with varying window lengths and numbers of averaged velocities), acceleration features, maximal diameter, and/or others.

A specific-user profile, in accordance with embodiments, may for example include one or more pupil positions, pupil rotational positions, pupil micro-movements and/or pupil trajectories along time—of that specific user. Non, or less frequently, repeating pupil positions, movements, trajectories, behaviors and/or patterns may be filtered-out-of/not-included-within the specific-user profile, or, may receive a lower factoring weight in comparison to more frequently reoccurring ones.

According to some embodiments, a set of monitored viewing-characteristics may include one or more continuous and/or reoccurring viewing-characteristics. Accordingly, monitored viewing-characteristics that are non-constant, temporary, occur for short time periods, and/or do not reoccur, may be filtered out from within monitored and acquired viewing-characteristics. A viewing-characteristics signature or profile, of a specific user, may accordingly be at least partially limited to viewing-characteristics that reoccur and/or occur along a period greater than a threshold length of time.

According to some embodiments, a set of monitored viewing-characteristics may further include one or more device display viewing distance, and/or device display orientation, related parameters that are detected, calculated and/or estimated for a specific user.

According to some embodiments, a comparison of a new set of monitored viewing-characteristics to stored records of viewing-characteristics (e.g. specific-user profiles/signatures) may be at least partially limited to viewing-characteristics obtained-during/associated-with correlated/similar user-environments, user-device-orientations and/or times-of-day. Comparison of new and stored viewing-characteristics—each obtained-during/associated-with non-correlated and/or non-similar user-environments—may be filtered out and removed from consideration, or, may be associated with smaller factoring/decision weights than comparisons associated with correlated viewing-characteristics.

According to some embodiments, comparing a new set of monitored viewing-characteristics to stored records (e.g. a specific-user profile/signature) may be executed between viewing-characteristics obtained-during/associated-with ‘points of comfort’ wherein usage parameters are substantially static over a time period. Or, wherein the longer the ‘points of comfort’ are the greater the factoring weight associated with that comparison.

According to some embodiments, comparing a new set of monitored viewing-characteristics to stored records (e.g. specific-user profiles/signatures) may include detection of elements/objects viewed/engaged by the user and comparison between viewing-characteristic sets associated with user viewing/engaging of similar elements/objects.

According to some embodiments, Viewing-Characteristics/Microsaccades profile comparison-evaluating how similar two Viewing-Characteristics/Microsaccades, or two sets of Viewing-Characteristics/Microsaccades, are and determining whether they belong-to/identify the same person—may utilize one or more distance functions factoring selected Microsaccade-features parameters/values and their respective weights. Utilized distance functions may for example include any combination of: (1) Linear distance functions; (2) Quasilinear distance functions; (3) Segment distance functions; (4) Segments set distance functions; (5) Error functions; and/or (6) Any other distance, matching, proximity, comparison and/or error correction functions.

A system for digital device display viewing-characteristics based authentication, in accordance with embodiments, may implement a “Login Screen” profile generation and authentication approach/method, including: (1) Creating a baseline profile by recording a user's eye movements while they view a standardized/specific screen, (e.g. a bank login page); and (2) Authenticating the user by comparing the user's current eye movements on that standardized/specific screen to their stored profile for that same screen.

A system for digital device display viewing-characteristics based authentication, in accordance with embodiments, may implement a “Cross-Content” profile generation and authentication approach/method, including: (1) Collecting eye-tracking data across multiple applications and scenarios (e.g. banking app, Gmail, reading an article, watching an online video); (2) Identifying behavioral patterns that are repetitive/consistent across such different application and scenario contexts; (3) Generating a cross-content user profile constituting a consistent, unique, biometric viewing-behavior “fingerprint” of that user; and (4) Authenticating the user by: (a) comparing the user's current eye movements-regardless of the application, scenario, context, or screen being interfaced/viewed—to their stored biometric viewing-behavior “fingerprint” profile: or, by (b) (i) comparing the user's current eye movements-regardless of the application, scenario, context, or screen being interfaced/viewed—to multiple stored biometric viewing-behavior “fingerprint” profiles, belonging to authorized/access-granted users, and (ii) authenticating the user, upon a comparison—between the user's current eye movements and one of the multiple stored biometric viewing-behavior “fingerprint” profiles belonging to authorized/access-granted users—indicating a distance smaller than a threshold distance value.

According to some embodiments, a system for digital device display viewing-characteristics based authentication may execute continuous authentication, wherein intermittent authentication checks are performed. The intermittent authentication checks may be performed after a user's successful initial authentication check based log in. Accordingly, a mobile digital device passed-to/now-used-by another user may fail a following authentication check and be detected by the system that may, in response: limit/remove previously granted access/credentials, identify the new user and provide access/credentials matching his profile, automatically freeze the application, and/or log out of it. Continuous authentication may be further used to identify which specific authorized user of a shared account performed a specific action and provide resource access or adapt the application user interface based thereon.

According to some embodiments, a system for digital device display viewing-characteristics based authentication may perform data verification using “Anchors”. To ensure that training data is accurate, or provide model training feedback, the system may “hook” onto other trusted authentication methods on the device. User authentication utilizing a reliable biometric such as face identification or a fingerprint scan, may serve as a verified “anchor”. Eye movement data captured following to, or immediately after, the anchored event may be considered of high reliability and may be used to strengthen the user's profile, for example, by assigning it with a greater weight than that of eye movement data that was captured without a recent anchor event and may thus be given a lower weight in the profile model. According to some embodiments, non-anchored eye movement data may be filtered out and not factored as part of user profile generation and/or AI model training.

According to some embodiments, an exemplary Static Fixation Signature Analysis method may authenticate a user based on the involuntary, fine-motor movements of their eyes when they are fixating on a specific point. The system may authenticate a user by capturing and analyzing their unique microsaccade signature during a moment of visual fixation, such as looking at a login icon or a specific “anchor point” on the screen.

According to some embodiments, the technical execution of a Static Fixation Signature Analysis method may include:

(1) Data Capture & Feature Extraction: When a user looks at a designated point on the display, the device's camera and Eye/Pupil Tracking Algorithm may capture a high-frequency data stream of pupil positions. This data may be processed to isolate fixational eye movements, such as: (a) Microsaccades: Measuring their rate (how often they occur), amplitude (how far they move), direction, and velocity; (b) Ocular Drift: Analyzing the slow, meandering motion of the eye between microsaccades; and/or (c) Ocular Tremor: Measuring the high-frequency, low-amplitude vibrations of the eye.

(2) Profile Generation: During an enrollment phase, these features may for example be collected over several seconds to create a multi-dimensional statistical model, or “signature”—to generate a probabilistic user profile that accounts for slight variations. For example, less-frequent patterns may be filtered out or given a lower weight in the final profile. Over time, this may become the user's stored Viewing-Characteristics Based Users' History/Profile.

(3) Authentication/Comparison: For authentication, the system may capture a new, short sample of the user's fixation. The Viewing-Characteristics Profile Comparison Algorithm/Logic may then compare the statistical properties of this new sample to the user's stored signature. If the similarity score is above a predetermined threshold, access may be granted, if not, access may be denied.

According to some embodiments, an exemplary Dynamic Gaze Trajectory Analysis method may authenticate a user by analyzing the unique way their eyes move while performing a simple, guided task on the screen. It may be combined with, and add a layer of active engagement, to the biometric signature. The system may authenticate a user by matching the characteristics of their gaze path to a stored, personalized template, as they follow a moving object or read a specific phrase on the display.

According to some embodiments, the technical execution of a Dynamic Gaze Trajectory Analysis method may include:

(1) Challenge-Response & Data Capture: The user is prompted to perform a quick task, such as following a dot that moves in a specific pattern/path on the screen. The Eye/Pupil Tracking Algorithm/Logic records the sequence of gaze coordinates over time, creating a “gaze trajectory”.

(2) Feature Extraction & Profile Generation: The Eye/Pupil Trajectory Analysis Algorithm/Logic analyzes this pattern/path, extracting key features. These features form the user's profile and may include: (a) Saccade & Fixation Analysis: The specific rhythm and characteristics of quick eye movements (saccades) and pauses (fixations) during the task; (b) Anticipatory/Corrective Movements: How the user's eye movements predict the target's path or correct for errors; and/or (c) Dynamic Time Warping (DTW): An algorithm that compares the geometric and temporal similarity of the new trajectory to a stored “template” trajectory for that user, even if the user performs the task slightly faster or slower.

(3) Authentication/Comparison: The newly captured trajectory's features are compared against the user's stored template(s). The system calculates a “cost” or “distance” score representing how much the new path deviates from the enrolled one. If the score is below a threshold, the user is successfully authenticated.

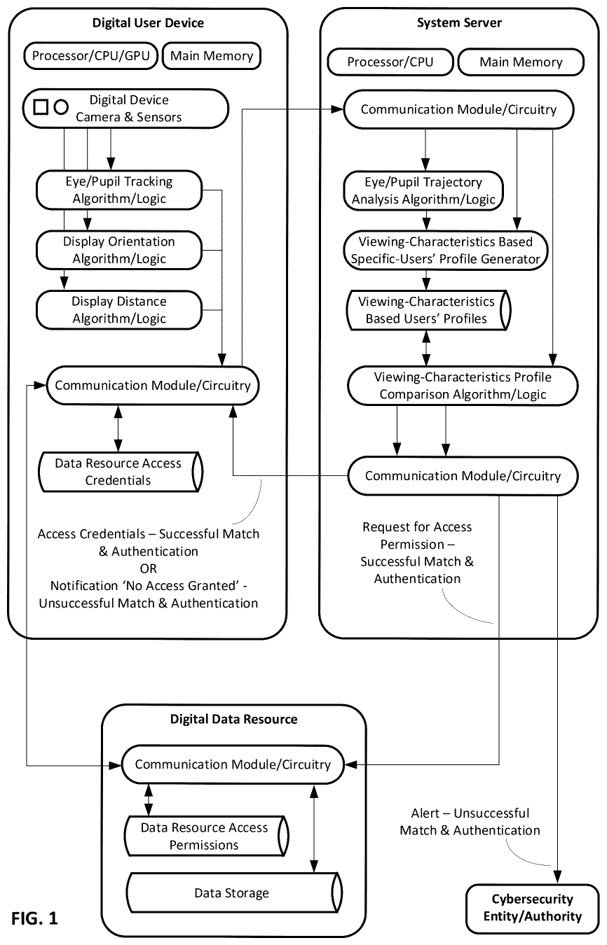

Reference is now made to FIG. 1, where there is shown a block diagram of an exemplary system for digital device display viewing-characteristics based authentication, in accordance with some embodiments. In the figure, an Eye/Pupil Tracking Algorithm/Logic, a Display Orientation Algorithm/Logic and a Display Distance Algorithm/Logic-receiving user viewing data from a camera and sensors of the shown digital user device-generate pupil tracking, device viewing distance and device orientation information, along time. The information is then relayed to the shown communication module/circuitry for communication to a system server.

The system server's Eye/Pupil Trajectory Analysis Algorithm/Logic analyses the information to generate eye/pupil trajectories typical to specific users. The generated eye/pupil trajectories, along with display distance and orientation information, are used to generate and store specific-user viewing characteristics profiles. Authentication/access requests from digital user devices, including newly acquired sets of viewing-characteristics, are compared by the Viewing-Characteristics Profile Comparison Algorithm/Logic to existing stored user profiles.

A successful comparison, as described herein, triggers the sending of access credentials to the associated digital user device and/or the sending of an access permission request, for the successfully matched user, to a Digital Data Resource/Storage/Network that the user wants to access. An unsuccessful comparison triggers the sending of a notification to the associated digital user device, informing the user that his authentication has failed and that access to the digital data resource is denied. An alert—of a possible unauthorized access attempt—is sent to a cybersecurity entity or authority, such as a security information and event management (SIEM), for further inspection and/or unauthorized access attempt handling.

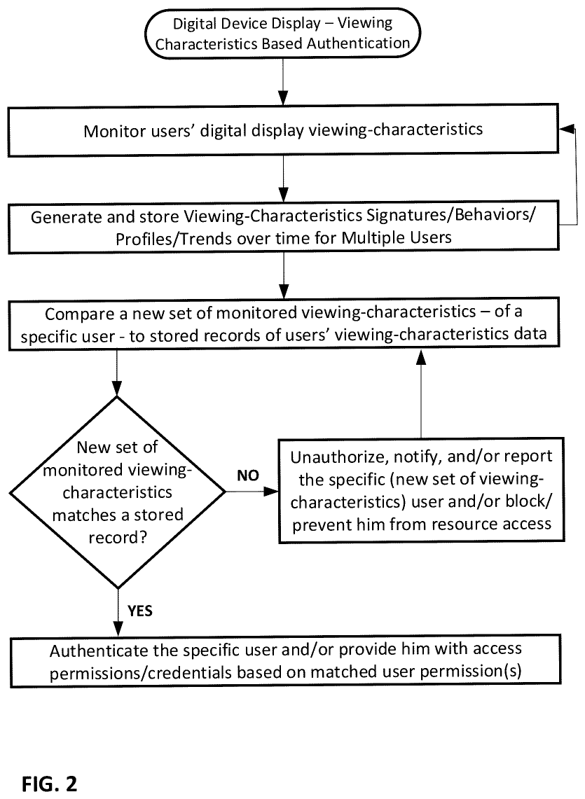

Reference is now made to FIG. 2, where there is shown a flowchart of an exemplary method for digital device display viewing-characteristics based authentication, in accordance with some embodiments.

Shown steps include: (1) Monitor users' digital display viewing-characteristics; (2) Generate and store Viewing-Characteristics Signatures, Behaviors, Profiles and/or Trends over time for Multiple Users; (3) Compare a new set of monitored viewing-characteristics—of a specific user—to stored profiles/records of users' viewing-characteristics data; (4) If the new set of monitored viewing-characteristics matches a stored profile/record then (a) Authenticate the specific user and/or provide him with access permissions/credentials based on matched user permission(s), else (b) Unauthorize, notify, and/or report the specific (new set of viewing-characteristics) user and/or block/prevent him from resource access.

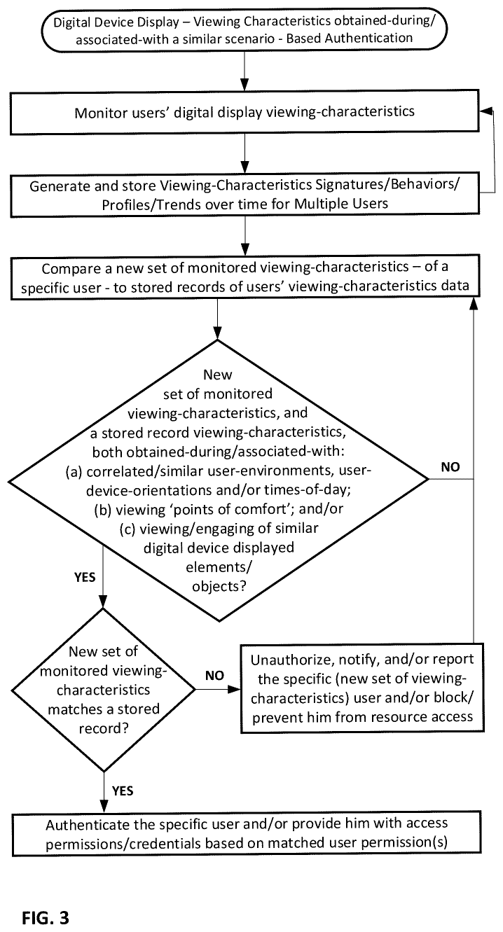

Reference is now made to FIG. 3, where there is shown a flowchart of an exemplary method for digital device display viewing-characteristics based authentication, wherein a new set of monitored viewing-characteristics, and a stored record viewing-characteristics, are both obtained-during/associated—with a similar scenario, in accordance with some embodiments.

Shown steps include: (1) Monitor users' digital display viewing-characteristics; (2) Generate and store Viewing-Characteristics Signatures, Behaviors, Profiles and/or Trends over time for Multiple Users; (3) Compare a new set of monitored viewing-characteristics—of a specific user—to stored profiles/records of users' viewing-characteristics data; (4) If the new set of monitored viewing-characteristics, and a stored record viewing-characteristics, are not both obtained-during/associated—with a similar scenario return to (3); else, continue to (5) If the new set of monitored viewing-characteristics matches a stored profile/record then (a) Authenticate the specific user and/or provide him with access permissions/credentials based on matched user permission(s), else (b) Unauthorize, notify, and/or report the specific (new set of viewing-characteristics) user and/or block/prevent him from resource access.

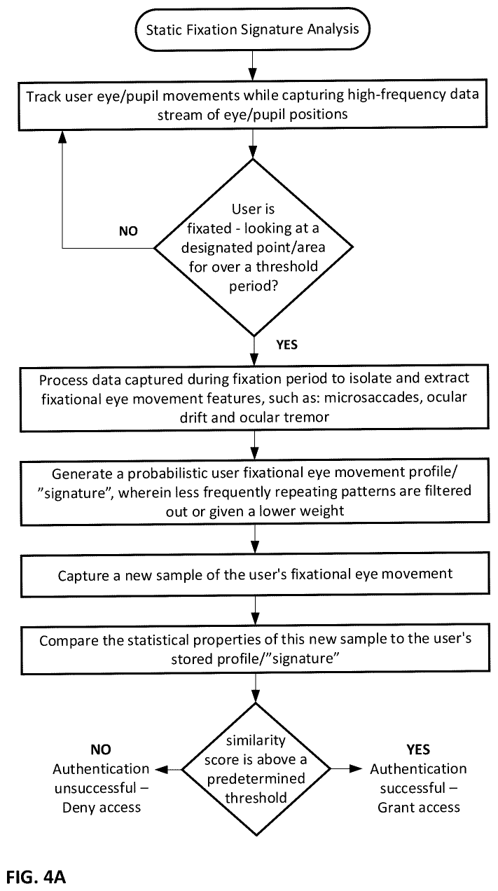

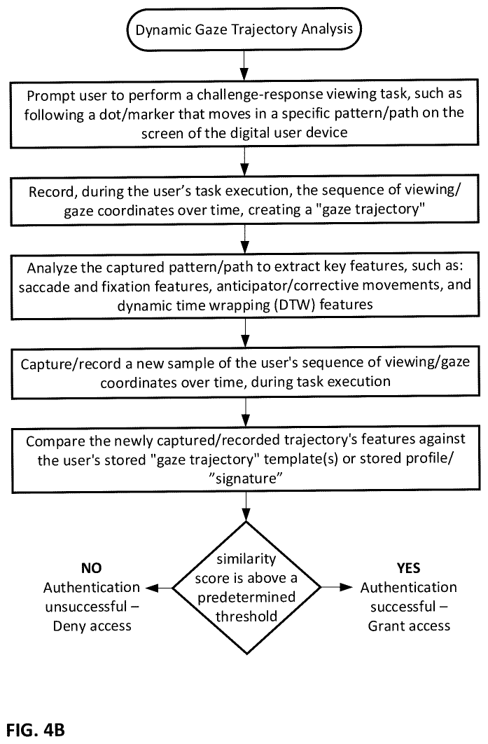

Reference is now made to FIG. 4A, where there is shown a flowchart of an exemplary, Static Fixation Signature Analysis based method for digital device display viewing-characteristics based authentication, wherein users are authenticated based on involuntary, fine-motor movements of their eyes when they are fixating on a specific point, in accordance with some embodiments.

Shown steps include: (1) Track user eye/pupil movements while capturing high-frequency data stream of eye/pupil positions; (2) If user is not fixated-looking at a designated point/area for over a threshold period-go back to (1); else, continue (3) Process data captured during fixation period to isolate and extract fixational eye movement features, such as: microsaccades, ocular drift and ocular tremor; (4) Generate a probabilistic user fixational eye movement profile/“signature”, wherein less frequently repeating patterns are filtered out or given a lower weight; (5) Capture a new sample of the user's fixational eye movement; (6) Compare the statistical properties of this new sample to the user's stored profile/“signature”; (7) If similarity score is above a predetermined threshold—Authentication successful—grant access; else (8) Authentication unsuccessful—deny access.

Reference is now made to FIG. 4B, where there is shown a flowchart of an exemplary, Dynamic Gaze Trajectory Analysis based method for digital device display viewing-characteristics based authentication, wherein users are authenticated by analyzing the unique way their eyes move while performing a guided task on a screen, in accordance with some embodiments.

Shown steps include: (1) Prompt user to perform a challenge-response viewing task, such as following a dot/marker that moves in a specific pattern/path on the screen of the digital user device; (2) Record, during the user's task execution, the sequence of viewing/gaze coordinates over time, creating a “gaze trajectory”; (3) Analyze the captured pattern/path to extract key features, such as: saccade and fixation features, anticipator/corrective movements, and dynamic time wrapping (DTW) features; (4) Capture/record a new sample of the user's sequence of viewing/gaze coordinates over time, during task execution; (5) Compare the newly captured/recorded trajectory's features against the user's stored “gaze trajectory” template(s) or stored profile/“signature”; (6) If similarity score is above a predetermined threshold—Authentication successful—grant access; else (7) Authentication unsuccessful—deny access.

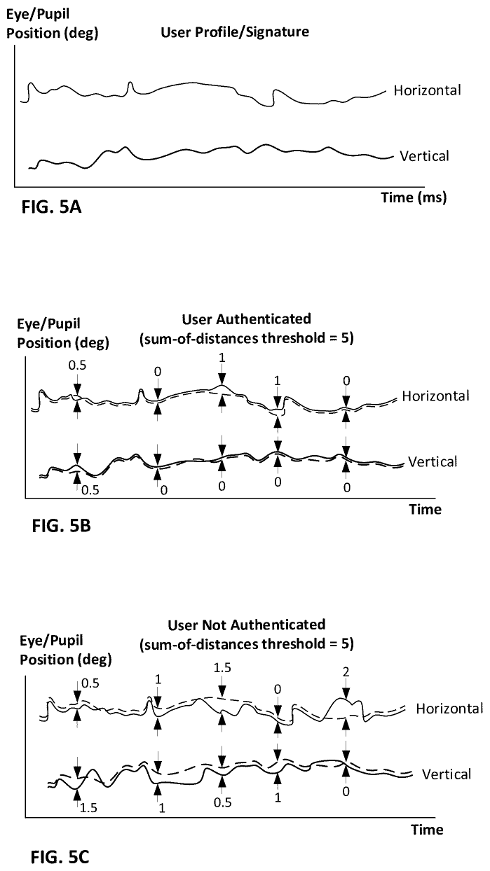

Reference is now made to FIG. 5A, where there is shown a simplified version of an exemplary ‘eye/pupil tracking over time’ based user profile/signature, of a system for digital device display viewing-characteristics based authentication, in accordance with some embodiments.

In the figure, a user's eye-movement profile/signature is depicted. The shown exemplary user signature represents the user's horizontal and vertical rotational eye/pupil position (in degrees) along a time (in milliseconds) period. The shown signature/profile may represent a central tendency measure, or a different inference/factoring, of multiple previously captured eye-movement patterns of that user. It will be understood that any other unit of angular measurement may be used for measuring the user's horizontal and vertical rotational eye/pupil position, such as radians or any other unit, without departing from the spirit of the invention.

Reference is now made to FIG. 5B, where there is shown a simplified exemplification of a successful, ‘eye/pupil tracking over time’ user profile/signature based, authentication, of a system for digital device display viewing-characteristics based authentication, in accordance with some embodiments.

In the figure, the user's eye-movement profile/signature of FIG. 5A (in broken line) is shown to be compared to a newly captured eye-movement pattern of that user. The differences/deltas measured—between the user's eye-movement profile/signature and the newly captured user eye-movement pattern—at specific sampled points, are shown to be [0.5; 0; 1:1; 0] for the horizontal position, and [0.5; 0; 0; 0; 0] for the vertical position. The sigma/sum of the distances is thus 2.5 (horizontal)+0.5 (vertical)=3. As the exemplary sum-of-distances threshold is set to 5, greater than the calculated sum of 3, the user is authenticated.

Reference is now made to FIG. 5C, where there is shown a simplified exemplification of an unsuccessful, ‘eye/pupil tracking over time’ user profile/signature based, authentication, of a system for digital device display viewing-characteristics based authentication, in accordance with some embodiments.

In the figure, the user's eye-movement profile/signature of FIG. 5A (in broken line) is shown to be compared to a newly captured eye-movement pattern of that user. The differences/deltas measured—between the user's eye-movement profile/signature and the newly captured user eye-movement pattern—at specific sampled points, are shown to be [0.5; 1; 1.5; 0; 2] for the horizontal position, and [1.5; 1; 0.5; 1; 0] for the vertical position. The sigma/sum of the distances is thus 5 (horizontal)+4 (vertical)=9. As the exemplary sum-of-distances threshold is set to 5, lesser than the calculated sum of 9, the user is not authenticated.

According to some embodiments of the present invention, any combination of the methods, systems, components, techniques, algorithms and/or or solutions, described herein in the context of digital device display viewing-characteristics based authentication, may be likewise utilized for visual impairment detection, assessment, diagnosis, trend analysis and/or remedy.

A system for digital device display viewing-characteristics based visual impairment detection, diagnosis and trend analysis, in accordance with embodiments, may facilitate the detection, diagnosis and trend analysis of a visual impairment of a digital device user based on one or more display viewing-characteristics of that user along time.

According to some embodiments, a system for digital device display viewing-characteristics based visual impairment detection, diagnosis and trend analysis may: (1) Monitor multiple users' digital display viewing-characteristics; (2) Generate and store viewing-characteristics values, signatures, behaviors, profiles and/or trends, along time, for multiple specific users; (3) Compare a new set of monitored viewing-characteristics data, of a specific user, to stored records of viewing-characteristics data of the same user; and/or (4) If a difference between the new set of monitored viewing-characteristics data of the specific user and one more of the stored, prior, record(s) of that specific user's viewing-characteristics data, is greater than a threshold value—indicate a possible visual impairment detection.

Viewing-characteristics, in accordance with embodiments, may include any type of eye or pupil positioning and/or movement, such as one or more pupil positions, and/or pupil micro-movements along a period of time. Multiple pupil positions along a period of time may be analyzed/processed to generate pupil trajectories typical to specific user(s).

A specific-user profile, in accordance with embodiments, may for example include one or more pupil positions, pupil micro-movements and/or pupil trajectories along time—of that specific user. Non, or less frequently, repeating pupil positions, movements, trajectories, behaviors and/or patterns may be filtered-out-of/not-included-within the specific-user profile, or, may receive a lower factoring weight in comparison to reoccurring ones.

According to some embodiments, a set of monitored viewing-characteristics may include one or more continuous and/or reoccurring viewing-characteristics. Accordingly, monitored viewing-characteristics that are non-constant, temporary, occur for short time periods, and/or do not reoccur, may be filtered out from within monitored and acquired viewing-characteristics. A viewing-characteristics signature or profile, of a specific user, may accordingly be at least partially limited to viewing-characteristics that reoccur and/or occur along a period greater than a threshold length of time.

According to some embodiments, a set of monitored viewing-characteristics may further include one or more device display viewing distance, and/or device display orientation, related parameters that are detected, calculated and/or estimated for a specific user.

According to some embodiments, a comparison of a new set of monitored viewing-characteristics, of a specific user, to stored records of viewing-characteristics of that specific user (e.g. specific-user profile/signature) may be at least partially limited to viewing-characteristics obtained-during/associated-with correlated/similar user-environments, user-device-orientations and/or times-of-day. Comparison of new and stored viewing-characteristics—each obtained-during/associated-with non-correlated and/or non-similar user-environments—may be filtered out and removed from consideration, or, may be associated with smaller factoring/decision weights than comparisons associated with correlated viewing-characteristics.

According to some embodiments, comparing a new set of monitored viewing-characteristics to stored records (e.g. a specific-user profile/signature) may be executed between viewing-characteristics obtained-during/associated-with ‘points of comfort’ wherein usage parameters are substantially static over a time period. Or, wherein the longer the ‘points of comfort’ are the greater the factoring weight associated with that comparison.

According to some embodiments, comparing a new set of monitored viewing-characteristics to stored records (e.g. specific-user profile/signature) may include detection of elements/objects viewed/engaged by the user and comparison between viewing-characteristic sets associated with the specific user viewing/engaging similar elements/objects.

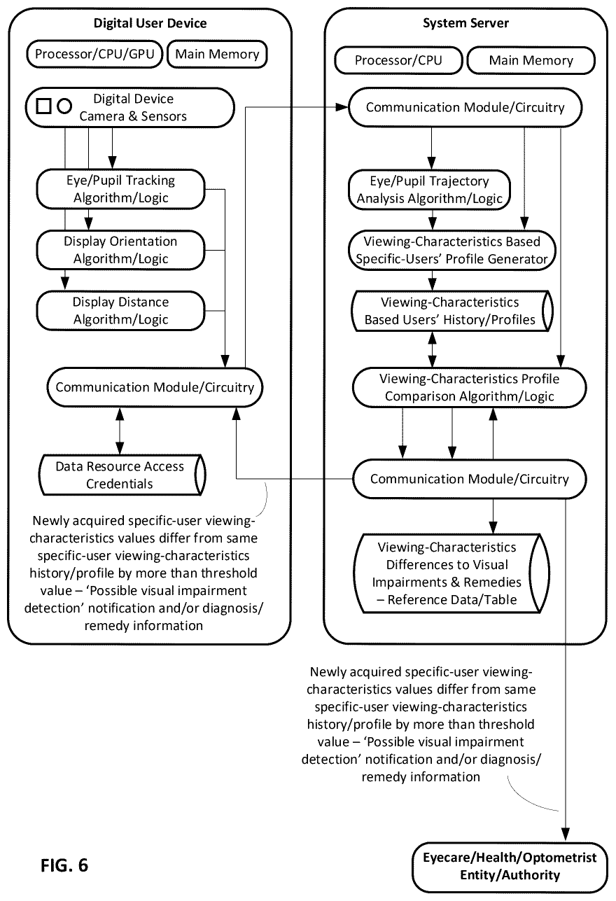

Reference is now made to FIG. 6, where there is shown a block diagram of an exemplary system for digital device display viewing-characteristics based visual impairment detection, diagnosis and trend analysis, in accordance with some embodiments.

In the figure, an Eye/Pupil Tracking Algorithm/Logic, a Display Orientation Algorithm/Logic and a Display Distance Algorithm/Logic-receiving user viewing data from a camera and sensors of the shown digital user device-generate pupil tracking, device viewing distance and device orientation information, along time. The information is then relayed to the shown communication module/circuitry for communication to a system server.

The system server's Eye/Pupil Trajectory Analysis Algorithm/Logic analyses the information to generate eye/pupil trajectories typical to specific users. The generated eye/pupil trajectories, along with display distance and orientation information, are used to generate and store specific-user viewing characteristics profiles. Newly acquired sets of viewing-characteristics, received from digital user devices, are compared by the Viewing-Characteristics Profile Comparison Algorithm/Logic to existing stored user profiles of the same specific users (i.e. Marry's new viewing-characteristics to Marry's viewing-characteristics history/profile; John's new viewing-characteristics to John's viewing-characteristics history/profile).

A comparison indicating a difference, greater than a threshold value(s), between value(s) representing the newly acquired specific-user viewing-characteristics and value(s) representing the same specific-user's viewing-characteristics history/profile, triggers the sending of a ‘possible visual impairment detection’ notification to the digital user device of the specific user associated with that comparison; and/or the sending of a ‘possible visual impairment detection’ notification to an eyecare/health/optometrist entity/authority of the specific user associated with that comparison.

The Viewing-Characteristics Profile Comparison Algorithm/Logic may, as shown in the figure, reference a Viewing-Characteristics Differences to Visual Impairments & Remedies-Reference Data/Table. The Reference Data/Table may be utilized by the comparison Algorithm/Logic to associate observed difference(s) between value(s) representing the newly acquired specific-user viewing-characteristics and value(s) representing the same specific-user's viewing-characteristics history/profile with corresponding diagnosis and/or remedies. For example, a smaller user eyes to display distance, and/or a slower changing user pupil trajectory, may suggest that the user is experiencing issues with reading/engaging displayed content that may indicate an emerging or worsening visual impairment.

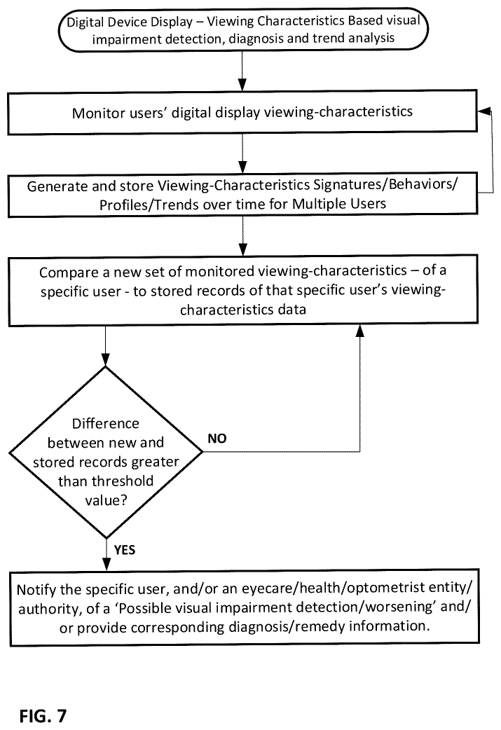

Reference is now made to FIG. 7, where there is shown a flowchart of an exemplary method for digital device display viewing-characteristics based visual impairment detection, diagnosis and trend analysis, in accordance with some embodiments.

Shown steps include: (1) Monitor users' digital display viewing-characteristics; (2) Generate and store Viewing-Characteristics Signatures, Behaviors, Profiles and/or Trends over time for Multiple Users; (3) Compare a new set of monitored viewing-characteristics—of a specific user—to stored profiles/records of that specific user's viewing-characteristics data; (4) If the difference(s) between the new set of monitored viewing-characteristics and stored profiles/records of that specific user's viewing-characteristics is/are greater than a threshold value(s), notify the specific user, and/or an eyecare/health/optometrist entity/authority, of a ‘Possible visual impairment detection/worsening’ and/or provide corresponding diagnosis/remedy information.

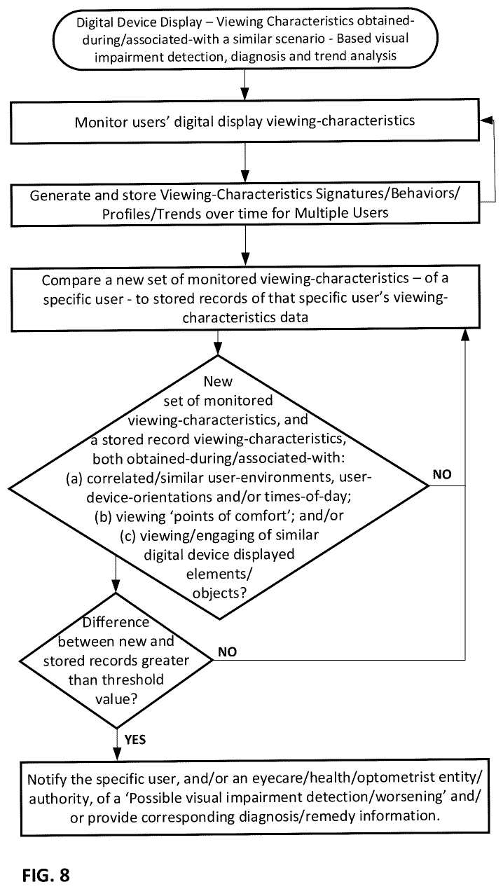

Reference is now made to FIG. 8, where there is shown a flowchart of an exemplary method for digital device display viewing-characteristics based visual impairment detection, diagnosis and trend analysis, wherein a new set of monitored viewing-characteristics, and a stored record viewing-characteristics, are both obtained-during/associated-with a similar scenario, in accordance with some embodiments.

Shown steps include: (1) Monitor users' digital display viewing-characteristics; (2) Generate and store Viewing-Characteristics Signatures, Behaviors, Profiles and/or Trends over time for Multiple Users; (3) Compare a new set of monitored viewing-characteristics—of a specific user—to stored profiles/records of that specific user's viewing-characteristics data; (4) If the new set of monitored viewing-characteristics, and a stored record viewing-characteristics, are not both obtained-during/associated-with a similar scenario return to (3); else, continue to (5) If the difference(s) between the new set of monitored viewing-characteristics and stored profiles/records of that specific user's viewing-characteristics is/are greater than a threshold value(s), notify the specific user, and/or an eyecare/health/optometrist entity/authority, of a ‘Possible visual impairment detection/worsening’ and/or provide corresponding diagnosis/remedy information.

According to some embodiments of the present invention, a system for digital device display viewing-characteristics based authentication may comprise: (1) an eye tracking logic to extract a display viewing-characteristics data set, of a user of the digital device, from image data acquired by a camera of the digital device; and (2) a system server comprising a display viewing-characteristics data comparison and authentication logic to: (a) compare the display viewing-characteristics data set of the user to one or more display viewing-characteristics user specific profiles, and (2) authenticate the user if the display viewing-characteristics data set matches a user profile from within the display viewing-characteristics user specific profiles.

According to some embodiments, each display viewing-characteristics user specific profile may factor multiple previously extracted display viewing-characteristics data sets of that user.

According to some embodiments, factoring previously extracted display viewing-characteristics data sets of the user may comprise applying a measure of central tendency to their parameter values.

According to some embodiments, less frequently appearing display viewing-characteristics data sets may be filtered out and not factored into the user specific profile.

According to some embodiments, non-repeating display viewing-characteristics data sets are filtered out and not factored into the user specific profile.

According to some embodiments, ‘non-anchored’ display viewing-characteristics data sets, extracted not within time proximity to a successful authentication of the user by a trusted authentication mechanism of the digital device, are filtered out and not factored into the user specific profile.

According to some embodiments, the eye tracking logic may be further adapted to detect periods of visual fixation of the user, wherein display viewing-characteristics data sets, extracted outside a period of detected visual fixation of the user, are filtered out and not factored into the user specific profile.

According to some embodiments, the eye tracking logic may, for example, detect periods of visual fixation of the user by: (1) detecting a first point of focus of the user over the display of the digital device; (2) setting a circumference or perimeter to define an area around the detected point of focus; (3) detecting at least a second, later, point of focus of the user; (4) determining if the second point of focus is within the defined area; (5) upon a second point of focus determined to be outside the defined area, measuring the time span between the detection time of the first point of focus and the detection time of the last second point of focus determined to be within the defined area; and (6) indicating the detection of a period of visual fixation of the user if the measured time span is greater than a threshold value.

According to some embodiments, comparison of the display viewing-characteristics data set of the user to one or more display viewing-characteristics user specific profiles may utilize a distance function to measure the level of similarity therebetween. A level of similarity above a threshold value may trigger the authentication of the user.

According to some embodiments, the display viewing-characteristics data comparison and authentication logic may be further adapted to intermittently execute additional authentication checks after an initial successful authentication check of the user.

According to some embodiments of the present invention, a method for digital device display viewing-characteristics based authentication may comprise: (1) extracting a display viewing-characteristics data set, of a user of the digital device, from image data acquired by a camera of the digital device; (2) comparing the display viewing-characteristics data set of the user to one or more display viewing-characteristics user specific profiles; and (3) authenticating the user if the display viewing-characteristics data set matches a user profile from within the display viewing-characteristics user specific profiles.

According to some embodiments, each display viewing-characteristics user specific profile may factor multiple previously extracted display viewing-characteristics data sets of that user.

According to some embodiments, factoring previously extracted display viewing-characteristics data sets of the user may comprise applying a measure of central tendency to their parameter values.

According to some embodiments, less frequently appearing display viewing-characteristics data sets may be filtered out and not factored into the user specific profile.

According to some embodiments, non-repeating display viewing-characteristics data sets may be filtered out and not factored into the user specific profile.

According to some embodiments, ‘non-anchored’ display viewing-characteristics data sets, extracted not within time proximity to a successful authentication of the user by a trusted authentication mechanism of the digital device, may be filtered out and not factored into the user specific profile.

According to some embodiments, the method may further comprise detecting periods of visual fixation of the user, wherein display viewing-characteristics data sets, extracted outside a period of detected visual fixation of the user, may be filtered out and not factored into the user specific profile.

According to some embodiments, detecting periods of visual fixation of the user may comprise: (1) detecting a first point of focus of the user over the display of the digital device;
setting a circumference or perimeter to define an area around the detected point of focus; (2) detecting at least a second, later, point of focus of the user; (3) determining if the second point of focus is within the defined area; (4) upon a second point of focus determined to be outside the defined area, measuring the time span between the detection time of the first point of focus and the detection time of the last second point of focus determined to be within the defined area; and (5) indicating the detection of a period of visual fixation of the user if the measured time span is greater than a threshold value.

According to some embodiments, comparison of the display viewing-characteristics data set of the user to one or more display viewing-characteristics user specific profiles may comprise utilizing a distance function to measure the level of similarity therebetween, wherein a level of similarity above a threshold value may trigger the authentication of the user.

According to some embodiments, the method may further comprise intermittently executing additional authentication checks after an initial successful authentication check of the user.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A system for digital device display viewing-characteristics based authentication, said system comprising:
an eye tracking logic to extract a display viewing-characteristics data set, of a user of said digital device, from image data acquired by a camera of said digital device; and
a system server comprising a display viewing-characteristics data comparison and authentication logic to:
compare the display viewing-characteristics data set of the user to one or more display viewing-characteristics user specific profiles; and
authenticate the user if the display viewing-characteristics data set matches a user profile from within the display viewing-characteristics user specific profiles.

2. The system according to claim 1, wherein each display viewing-characteristics user specific profile factors multiple previously extracted display viewing-characteristics data sets of that user.

3. The system according to claim 2, wherein factoring previously extracted display viewing-characteristics data sets of the user comprises applying a measure of central tendency to their parameter values.

4. The system according to claim 2, wherein less frequently appearing display viewing-characteristics data sets are filtered out and not factored into the user specific profile.

5. The system according to claim 2, wherein non-repeating display viewing-characteristics data sets are filtered out and not factored into the user specific profile.

6. The system according to claim 2, wherein ‘non-anchored’ display viewing-characteristics data sets, extracted not within time proximity to a successful authentication of the user by a trusted authentication mechanism of said digital device, are filtered out and not factored into the user specific profile.

7. The system according to claim 2, wherein said eye tracking logic is further adapted to detect periods of visual fixation of the user, wherein display viewing-characteristics data sets, extracted outside a period of detected visual fixation of the user, are filtered out and not factored into the user specific profile.

8. The system according to claim 7, wherein said eye tracking logic detects periods of visual fixation of the user by:
detecting a first point of focus of the user over the display of said digital device;
setting a circumference or perimeter to define an area around the detected point of focus;
detecting at least a second, later, point of focus of the user;
determining if the second point of focus is within the defined area;
upon a second point of focus determined to be outside the defined area, measuring the time span between the detection time of the first point of focus and the detection time of the last second point of focus determined to be within the defined area; and
indicating the detection of a period of visual fixation of the user if the measured time span is greater than a threshold value.

9. The system according to claim 1, wherein comparison of the display viewing-characteristics data set of the user to one or more display viewing-characteristics user specific profiles utilizes a distance function to measure the level of similarity therebetween; and
wherein a level of similarity above a threshold value triggers the authentication of the user.

10. The system according to claim 1, wherein said display viewing-characteristics data comparison and authentication logic is further adapted to intermittently execute additional authentication checks after an initial successful authentication check of the user.

11. A method for digital device display viewing-characteristics based authentication, said method comprising:
extracting a display viewing-characteristics data set, of a user of the digital device, from image data acquired by a camera of the digital device;
comparing the display viewing-characteristics data set of the user to one or more display viewing-characteristics user specific profiles; and
authenticating the user if the display viewing-characteristics data set matches a user profile from within the display viewing-characteristics user specific profiles.

12. The method according to claim 11, wherein each display viewing-characteristics user specific profile factors multiple previously extracted display viewing-characteristics data sets of that user.

13. The method according to claim 12, wherein factoring previously extracted display viewing-characteristics data sets of the user comprises applying a measure of central tendency to their parameter values.

14. The method according to claim 12, wherein less frequently appearing display viewing-characteristics data sets are filtered out and not factored into the user specific profile.

15. The method according to claim 12, wherein non-repeating display viewing-characteristics data sets are filtered out and not factored into the user specific profile.

16. The method according to claim 12, wherein ‘non-anchored’ display viewing-characteristics data sets, extracted not within time proximity to a successful authentication of the user by a trusted authentication mechanism of the digital device, are filtered out and not factored into the user specific profile.

17. The method according to claim 12, further comprising detecting periods of visual fixation of the user, wherein display viewing-characteristics data sets, extracted outside a period of detected visual fixation of the user, are filtered out and not factored into the user specific profile.

18. The method according to claim 17, wherein detecting periods of visual fixation of the user comprises:
detecting a first point of focus of the user over the display of the digital device;
setting a circumference or perimeter to define an area around the detected point of focus;
detecting at least a second, later, point of focus of the user;
determining if the second point of focus is within the defined area;
upon a second point of focus determined to be outside the defined area, measuring the time span between the detection time of the first point of focus and the detection time of the last second point of focus determined to be within the defined area; and
indicating the detection of a period of visual fixation of the user if the measured time span is greater than a threshold value.

19. The method according to claim 11, wherein comparison of the display viewing-characteristics data set of the user to one or more display viewing-characteristics user specific profiles comprises utilizing a distance function to measure the level of similarity therebetween; and
wherein a level of similarity above a threshold value triggers the authentication of the user.

20. The method according to claim 11, further comprising intermittently executing additional authentication checks after an initial successful authentication check of the user.
